(19) United States
(12) Patent Application Publication
(10) Pub. No.: US 2006/0294310 A1
(43) Pub. Date: Dec. 28, 2006

(54) Write control method and storage apparatus

(75) Inventor: Yutaka Horiguchi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/231,404

(22) Filed: Sep. 21, 2005

(30) Foreign Application Priority Data
Jun. 22, 2005 (JP) 2005-181732

(51) Int. Cl. G06F 12/00

(52) U.S. Cl. 711/118

(57) ABSTRACT

A write control method controls writing of data to a recording medium in a storage apparatus by using a write cache process. The write control method confirms an alternate number or an alternate area utilization rate within each data area of the recording medium based on the alternate process information, and sets to a disabled state the write cache process with respect to an arbitrary data area to which data specified by a data write command are to be written, when the alternate number or the alternate area utilization rate within the arbitrary data area is greater than or equal to a prescribed value.

### BACKGROUND OF THE INVENTION

1. Field of the Invention

The present invention generally relates to write control methods and storage apparatuses, and more particularly to a write control method for controlling a write cache process that temporarily stores information in a storage part within a storage apparatus before writing the information on a recording medium when writing the information from a host unit to the recording medium within the storage apparatus, and to a storage apparatus that employs such a write control method.

2. Description of the Related Art

In a storage apparatus using a magneto-optical disk as the recording medium, an automatic alternate process (or an automatic reallocation process) is carried out when a defect of the recording medium is detected so as to write the data to be written into an alternate area. In addition, in order to increase the data write speed, a write cache process is carried out in response to a write command from a host unit. When writing the data to the recording medium within the storage apparatus, the write cache process temporarily stores the data in a storage part within the storage apparatus, and after returning a data normal acceptance complete status to the host unit, actually writes the data stored in the storage part to the recording medium. Recently, in order to further improve the efficiency of the write cache process, a cache buffer memory having a large storage capacity is used as the storage part within the storage apparatus. The write cache process is sometimes also referred to as a delayed write process or a write back process.

However, when the alternate process is carried out, a write retry-out error may occur. According to the write retry-out error, an error is generated even when the alternate process is carried out with respect to a data block, an error is generated even when the alternate process is carried out again, and an error is generated even after carrying out the alternate process a predetermined number of times, thereby causing a write retry process to fail.

According to the specification of the storage apparatus, the data stored in the cache buffer memory within the storage apparatus is invalidated when the data write process is completed. Hence, the data that could not be written due to the write retry-out error will be lost. This is because there is a limit to the storage capacity of the cache buffer memory. The completion of the data write process includes both the normal end and the abnormal end of the data write process.

On the other hand, the host unit must issue an instruction with respect to the storage apparatus so as to carry out the write retry process with respect to the data block where the write error occurred. However, in general, when the host unit receives the data normal acceptance complete status that is returned from a controller within the storage apparatus, the host unit is constructed to invalidate the data that are held in a memory within the host unit. For this reason, the write retry process cannot be carried out by transferring the data from the host unit. Therefore, the data to be written to the recording medium will be lost not only from the cache buffer memory within the storage apparatus, but also from the memory within the host unit, and there are cases where the lost data cannot be remedied.

Accordingly, in order to eliminate the inconveniences described above, a U.S. Pat. No. 5,379,276 proposes a method of discontinuing the write cache process depending on a state of the alternate process to the recording medium.

However, according to the method proposed in the U.S. Pat. No. 5,379,276, the write cache process is discontinued with respect to the entire recording medium if a defect is generated in a portion of the recording medium due to foreign particles such as dust particles and damages such as scratches on the recording medium. Consequently, there was a problem in that the efficiency of the write cache process greatly deteriorates in such a case.

### SUMMARY OF THE INVENTION

Accordingly, it is a general object of the present invention to provide a novel and useful write control method and storage apparatus, in which the problems described above are suppressed.

Another and more specific object of the present invention is to provide a write control method and a storage apparatus that can prevent the efficiency of the write cache process from deteriorating.

Still another object of the present invention is to provide a write control method for controlling writing of data to a recording medium in a storage apparatus by using a write cache process, where the recording medium comprises a plurality of data areas to which data are written, a plurality of alternate areas, provided correspondingly to the data areas, to which data to be written are written by an alternate process, and at least one management area to store alternate process information for managing the alternate areas, and the write control method comprises a confirmation step confirming an alternate number or an alternate area utilization rate within each data area based on the alternate process information, the alternate number indicating a number of alternate processes or a number of alternate areas used; and a set step setting to a disabled state the write cache process with respect to an arbitrary data area to which data specified by a data write command are to be written, when the alternate number or the alternate area utilization rate within the arbitrary data area is greater than or equal to a prescribed value. According to the write control method of the present invention, it is possible to efficiently switch the write cache process depending on the state of the alternate process in each area of the recording medium.

A further object of the present invention is to provide a storage apparatus for controlling writing of data to a recording medium by using a write cache process, where the recording medium comprises a plurality of data areas to which data are written, a plurality of alternate areas, provided correspondingly to the data areas, to which data to be written are written by an alternate process, and at least one management area to store alternate process information for managing the alternate areas, and the storage apparatus comprises a storage part; a confirmation part configured to confirm an alternate number or an alternate area utilization rate within each data area based on the alternate process information, the alternate number indicating a number of alternate processes or a number of alternate areas used; and a set part configured to set to a disabled state the write cache process with respect to an arbitrary data area to which data specified by a data write command are to be written, when the alternate number or the alternate area utilization rate within the arbitrary data area is greater than or equal to a prescribed value. According to the storage apparatus of the present invention, it is possible to efficiently switch the write cache process depending on the state of the alternate process in each area of the recording medium.

Other objects and further features of the present invention will be apparent from the following detailed description when read in conjunction with the accompanying drawings.

### BRIEF DESCRIPTION OF THE DRAWINGS

FIG. 1 is a diagram showing an important part of an embodiment of a storage apparatus according to the present invention;

FIG. 2 is a diagram showing a recording region of a recording medium; and

FIG. 3 is a flow chart for explaining an embodiment of a write control method according to the present invention.

### DESCRIPTION OF THE PREFERRED EMBODIMENTS

A description will be given of embodiment of a storage apparatus according to the present invention and a write control method according to the present invention, by referring to the drawings.

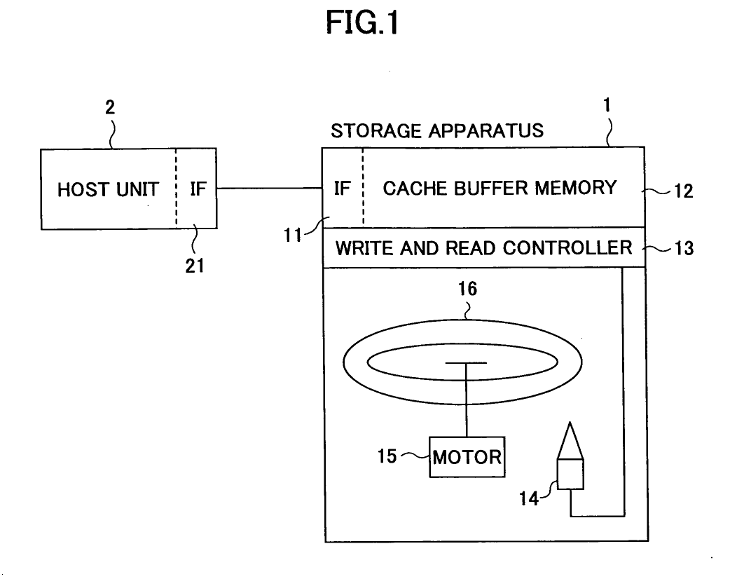

FIG. 1 is a diagram showing an important part of an embodiment of the storage apparatus according to the present invention. In this embodiment of the storage apparatus, the present invention is applied to a magneto-optical disk drive.

In FIG. 1, a storage apparatus 1 has a basic structure including an interface (IF) part 11, a cache buffer memory 12 that is used as a storage part, a write and read controller 13, a head 14, and a spindle motor 15. This basic structure itself is known, but it is of course possible to employ other known basic structures for the storage apparatus 1. A magneto-optical disk 16 that is used as a recording medium is rotated by the spindle motor 15 according to a known method. The magneto-optical disk 16 may be removable with respect to the storage apparatus 1, that is loadable and unloadable with respect to the storage apparatus 1.

On the other hand, a host unit 2 is formed by a personal computer or the like having a known structure, and an interface (IF) part 21. The interface part 21 of the host unit 2 and the interface part 11 of the storage apparatus 1 are connected by a cable or a wireless connection.

When a write command (or a write request) is issued from the host unit 2, the write command is supplied to the write and read controller 13 within the storage apparatus 1, via the interface parts 21 and 11. The write and read controller 13 is formed by a memory and a processor such as a CPU. The write and read controller 13 controls a moving mechanism (not shown) or the like to move the head 14 depending on address information included in the write command, and controls a write cache process that temporarily stores write data obtained from the host unit 2 in the cache buffer memory 12 and, after returning a data normal acceptance complete status to the host unit 2, actually writes on the magneto-optical disk 16 the write data stored in the cache buffer memory 12.

On the other hand, when a read command (or a read request) is issued from the host unit 2, the read command is supplied to the write and read controller 13 within the storage apparatus 1, via the interface parts 21 and 11. The write and read controller 13 controls the moving mechanism or the like to move the head 14 depending on the address information included in the read command, and a read process that temporarily stores the data read from the magneto-optical disk 16 in the cache buffer memory 12 before supplying the read data to the host unit 2 via the interface parts 11 and 21.

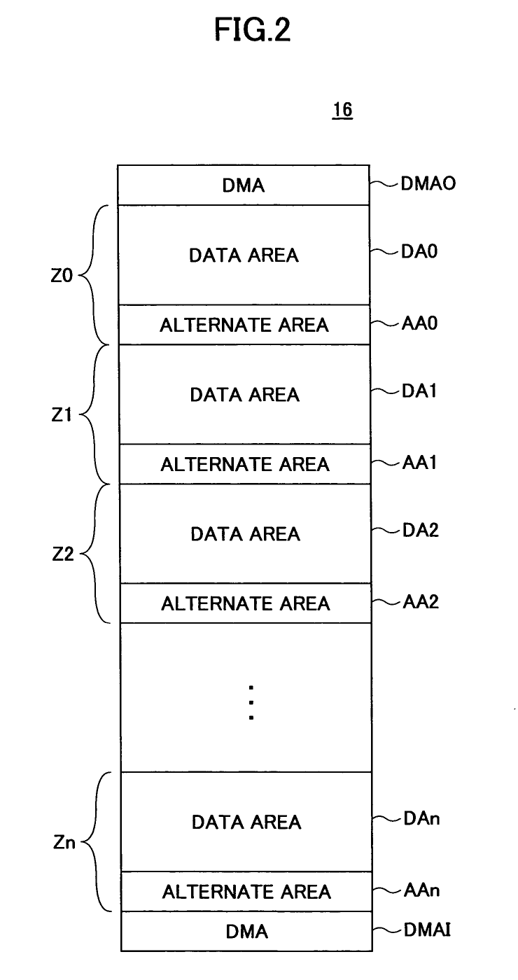

FIG. 2 is a diagram showing a recording region of a recording medium. In this embodiment, it is assumed for the sake of convenience that the magneto-optical disk 16 includes zones Z0 through Zn, and defect management areas DMAI and DMAO. The zones Z0 through Zn segment a recording region of the magneto-optical disk 16 into a plurality of areas (or regions) along a radial direction. The defect management areas DMAI and DMAO are respectively provided at an inner peripheral portion and an outer peripheral portion of the magneto-optical disk 16. Of course, the number of defect management areas and the locations of the defect management areas on the magneto-optical disk 16 are not limited to those shown in FIG. 2.

Each zone Zi is made up of a corresponding data area (or data region) Dai and at least one corresponding alternate area (or alternate region) AAi, where i=0 to n. The data are recorded in each data area Dai. If a defect or the like exists in the data area DAi, the data to be written to the data area Dai are written to the corresponding alternate area AAi. Alternate process information DDS, PDL, SDL and the like is stored in each of the defect management areas DMAI and DMAO by a known method. The alternate process information DDS refers to the Disk Definition Sector or Disk Definition Structure for storing management information of the magneto-optical disk 16, and stores starting positions of the PDL and SDL and the like. The alternate number or the utilization rate of the alternate area within the corresponding zone (that is, the data area) may be stored in the defect management area.

The alternate number indicates the number of alternate processes or the number of alternate areas used. The alternate number may be counted from the alternate process information DDS, PDL and SDL, and stored in the memory in a manner usable by the processor. The utilization rate of the alternate area (hereinafter referred to as an alternate area utilization rate) indicates the proportion of the storage capacity of the region that already stores data within one alternate area with respect to the total storage capacity of this one alternate area. Instead of storing the alternate area utilization rate in the alternate area of the recording medium, it is possible to compute the alternate area utilization rate by the processor and store the alternate area utilization rate in the memory in a manner usable by the processor.

The alternate process information PDL refers to the Primary Defect List for storing addresses of defective sectors within a corresponding zone (that is, data area) that are detected by a surface inspection at the time when the magneto-optical disk 16 is manufactured. The alternate process information SDL refers to the Secondary Defect List for storing addresses of defective sectors within a corresponding zone (that is, data area) that are generated when the magneto-optical disk 16 is used in the storage apparatus 1.

Each of the zones Z0 through Zn may be a region that is obtained by segmenting the region of the recording medium such as the magneto-optical disk 16 in the radial direction thereof or, may be the zone that is used in the Zone-CAV system or the Zone-CLV system.

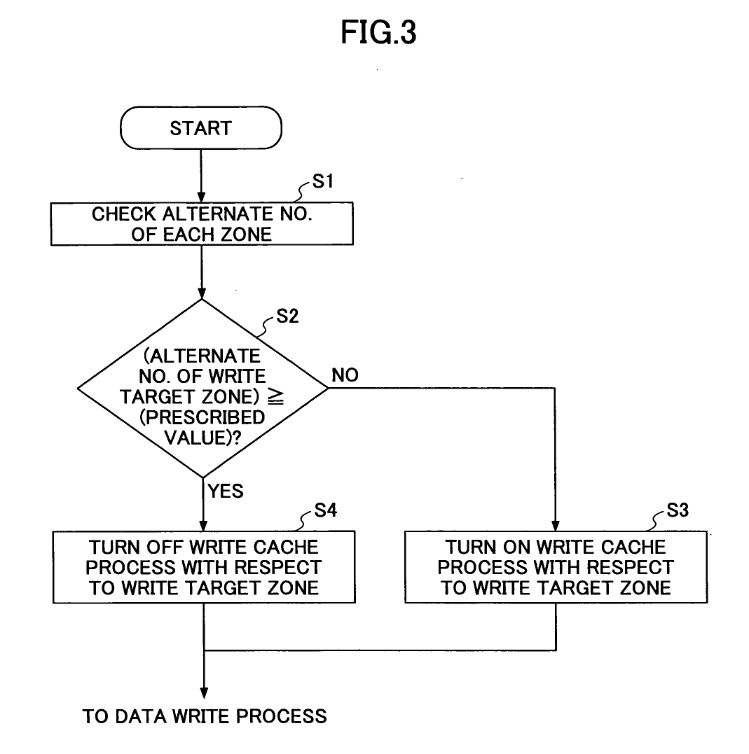

FIG. 3 is a flow chart for explaining an embodiment of a write control method according to the present invention. For example, the process shown in FIG. 3 is carried out by the processor of the write and read controller 13 within the storage apparatus 1 shown in FIG. 1, when a write command issued from the host unit 2 is received by the storage apparatus 1 in a state where the magneto-optical disk 16 is loaded into the storage apparatus 1. It is assumed for the sake of convenience that, when the magneto-optical disk 16 is first loaded into the storage apparatus 1, the defect management area of the magneto-optical disk 16 is read so as to read the alternate process information within each of the alternate areas AA0 through AAn and store the alternate process information into the cache buffer memory 12 in advance. In addition, when the alternate process is carried out, it is assumed that the alternate process information stored in the cache buffer memory 12 is updated by a known method. In this state, if the alternate number and the alternate area utilization rate are not stored in the magneto-optical disk 16, the alternate number and the alternate area utilization rate are obtained by counting or computation based on the alternate process information.

In FIG. 3, a step S1 reads the alternate process information within each of the alternate areas AA0 through AAn of the magneto-optical disk 16, that is prestored in the cache buffer memory 12, and checks the alternate number or the alternate area utilization rate within each of the zones Z0 through Zn. A step S2 detects a write target zone to which the data are to be written, from the address that is included in the write command, and decides whether or not the alternate number or the alternate area utilization rate within the write target zone is greater than or equal to a prescribed value. The prescribed value is an arbitrary value that is preset in the memory within the write and read controller 13, and may be variably set depending on the using style of the user.

If the decision result in the step S2 is NO, a step S3 sets the write cache process with respect to the write target zone to an ON state, that is, an enabled state, and the process advances to a data write process (not shown) similar to that of the conventional storage apparatus. On the other hand, if the decision result in the step S2 is YES, a step S4 writes the data already stored in the cache buffer memory 12 to the magneto-optical disk 16, and thereafter sets the write cache process with respect to the write target zone to an OFF state, that is, a disabled state, and the process advances to the data write process (not shown) similar to that of the conventional storage apparatus. Hence, the storage apparatus 1 checks the alternate number or the alternate area utilization rate within the write target zone every time the write command is received from the host unit 2, and if the alternate number or the alternate area utilization rate is greater than or equal to the prescribed value, the data that are already stored in the cache buffer memory 12 are written to the magneto-optical disk 16 before setting the write cache process with respect to the write target zone to the disabled state.

Instead of carrying out the step S1 every time the storage apparatus 1 receives the write command from the host unit 2, the step S1 may be carried out when the magneto-optical disk 16 is loaded into the storage apparatus so as to put the storage apparatus 1 in a command wait state that waits for a command from the host unit 2. In this case, the step S2 and the subsequent steps may be carried out when the storage apparatus 1 receives the write command that is issued from the host unit 2.

In this embodiment, it is possible to realize a high data write reliability with respect to each zone, by confirming the alternate number or the alternate area utilization rate within the write target zone. For example, in a case where the defect such as the foreign particles and damages on the magneto-optical disk 16 only exists in a portion of the recording region of the magneto-optical disk 16, the alternate process increases only in the zones including this portion of the recording region. Hence, by setting to the disabled state only the write cache process with respect to the zones in which the alternate number or the alternate area utilization rate is greater than or equal to the prescribed value as in this embodiment, each zone can be utilized efficiently, because it is possible to realize a high data write reliability with respect to the zones in which the alternate number or the alternate area utilization rate is greater than or equal to the prescribed value. In addition, the write cache process with respect to the other zones in which the alternate number or the alternate area utilization rate is less than the prescribed value is set to the enabled state because it is judged that a satisfactory data write quality is obtainable in these other zones, and the data write speed will not be deteriorated by the write cache process when viewed from the host unit 2 (that is, the user). According to the specification of the storage apparatus 1, the data stored in the cache buffer memory 12 within the storage apparatus 1 are invalidated when the data write process is completed (including both cases where the normal end and the abnormal end of the data write process occurs). Hence, if the write cache process is set to the enabled state, the data that could not be written due to the write retry-out error will be lost. However, in this embodiment, the data stored in the cache buffer memory 12 will not be invalidated even when the write retry process fails and the write error occurs, if the write cache process is set to the disabled state. As a result, the host unit 2 can carry out the write retry process with respect to the data block that was issued immediately before and for which the write error occurred, and thus, it is possible to reduce the probability of losing the data due to not being able to carry out the write retry process.

In the embodiment described above, the present invention is applied to the magneto-optical disk drive. However, the present invention is of course similarly applicable to other storage apparatus using other recording media such as magnetic disks and DVD-RAMs. In addition, the recording region of the recording medium used by the storage apparatus is not limited to the structure shown in FIG. 2, and for example, one alternate area may be provided with respect to a plurality of data areas.

This application claims the benefit of a Japanese Patent Application No.2005-181732 filed Jun. 22, 2005, in the Japanese Patent Office, the disclosure of which is hereby incorporated by reference.

Further, the present invention is not limited to these embodiments, but various variations and modifications may be made without departing from the scope of the present invention.

What is claimed is:

1. A write control method for controlling writing of data to a recording medium in a storage apparatus by using a write cache process, said recording medium comprising a plurality of data areas to which data are written, a plurality of alternate areas, provided correspondingly to the data areas, to which data to be written are written by an alternate process, and at least one management area to store alternate process information for managing the alternate areas, said write control method comprising:
a confirmation step confirming an alternate number or an alternate area utilization rate within each data area based on the alternate process information, said alternate number indicating a number of alternate processes or a number of alternate areas used; and
a set step setting to a disabled state the write cache process with respect to an arbitrary data area to which data specified by a data write command are to be written, when the alternate number or the alternate area utilization rate within the arbitrary data area is greater than or equal to a prescribed value.

2. The write control method as claimed in claim 1, wherein the set step sets the write cache process with respect to the arbitrary data area to an enabled state, when the alternate number or the alternate area utilization rate within the arbitrary data area is less than the prescribed value.

3. The write control method as claimed in claim 1, wherein:
the recording medium comprises a disk having a recording region that is segmented into a plurality of zones in a radial direction thereof;
each of the zones includes one data area and one corresponding alternate area; and
the management area is provided in at least one of an inner peripheral portion and an outer peripheral portion of the disk.

4. The write control method as claimed in claim 1, wherein the prescribed value is variably set.

5. The write control method as claimed in claim 1, wherein the set step sets the write cache process with respect to the arbitrary data area to the disabled state after writing data that are already stored in a storage part within the storage apparatus to the recording medium, when the alternate number or the alternate area utilization rate within the arbitrary data area is greater than or equal to the prescribed value.

6. The write control method as claimed in claim 1, wherein the confirmation step confirms the alternate process information within each data area, that is stored in advance in a storage part within the storage apparatus, when the recording medium is loaded into the storage apparatus.

7. A storage apparatus for controlling writing of data to a recording medium by using a write cache process, said recording medium comprising a plurality of data areas to which data are written, a plurality of alternate areas, provided correspondingly to the data areas, to which data to be written are written by an alternate process, and at least one management area to store alternate process information for managing the alternate areas, said storage apparatus comprising:
a storage part;
a confirmation part configured to confirm an alternate number or an alternate area utilization rate within each data area based on the alternate process information, said alternate number indicating a number of alternate processes or a number of alternate areas used; and
a set part configured to set to a disabled state the write cache process with respect to an arbitrary data area to which data specified by a data write command are to be written, when the alternate number or the alternate area utilization rate within the arbitrary data area is greater than or equal to a prescribed value.

8. The storage apparatus as claimed in claim 7, wherein the set part sets the write cache process with respect to the arbitrary data area to an enabled state, when the alternate number or the alternate area utilization rate within the arbitrary data area is less than the prescribed value.

9. The storage apparatus as claimed in claim 7, wherein:
the recording medium comprises a disk having a recording region that is segmented into a plurality of zones in a radial direction thereof;
each of the zones includes one data area and one corresponding alternate area; and
the management area is provided in at least one of an inner peripheral portion and an outer peripheral portion of the disk.

10. The storage apparatus as claimed in claim 7, wherein the prescribed value is variably set.

11. The storage apparatus as claimed in claim 7, wherein the set part sets the write cache process with respect to the arbitrary data area to the disabled state after writing data that are already stored in the storage part to the recording medium, when the alternate number or the alternate area utilization rate within the arbitrary data area is greater than or equal to the prescribed value.

12. The storage apparatus as claimed in claim 7, wherein the confirmation part confirms the alternate process information within each data area, that is stored in advance in the storage part, when the recording medium is loaded into the storage apparatus.
